(19) United States
(12) Patent Application Publication
(10) Pub. No.: US 2026/0253797 A1
(43) Pub. Date: Aug. 27, 2026

(54) METHOD FOR MANUFACTURING MULTILAYER ELECTRONIC COMPONENT AND METHOD FOR MANUFACTURING CERAMIC GREEN SHEET

(71) Applicant: SAMSUNG ELECTRO-MECHANICS CO., LTD., Suwon-si (KR)

(72) Inventors: Yeong Ju Choe, Suwon-si (KR); Ji Woo Heo, Suwon-si (KR); Da Jeong Lee, Suwon-si (KR)

(73) Assignee: SAMSUNG ELECTRO-MECHANICS CO., LTD., Suwon-si (KR)

(21) Appl. No.: 19/461,238

(22) Filed: Jan. 27, 2026

(30) Foreign Application Priority Data
Feb. 24, 2025 (KR) 10-2025-0023405

(51) Int. Cl. H01G 4/012; B32B 37/10; C04B 35/64; H01G 4/12; H01G 4/30

(52) U.S. Cl. CPC H01G 4/012; B32B 37/10; C04B 35/64; H01G 4/1227; C04B 2235/604; H01G 4/30

(57) ABSTRACT

A method for manufacturing a multilayer electronic component includes applying a dielectric slurry onto a film and drying the dielectric slurry to form a ceramic green sheet; performing an HRP process on the ceramic green sheet to form a compressed ceramic green sheet; forming an internal electrode pattern on the compressed ceramic green sheet; forming a laminate by laminating the compressed ceramic green sheet having the internal electrode pattern formed thereon; forming a body including a dielectric layer and an internal electrode by sintering the laminate; and forming an external electrode on the body, wherein the HRP process applies a temperature of 50°C to 70°C and a pressure of 10 MPa to 20 MPa.

### CROSS-REFERENCE TO RELATED APPLICATION(S)

This application claims benefit of priority to Korean Patent Application No. 10-2025-0023405 filed on February 24, 2025, the disclosure of which is incorporated herein by reference in their entireties.

### TECHNICAL FIELD

The present disclosure relates to a method for manufacturing a multilayer electronic component and a method for manufacturing a ceramic green sheet.

A multilayer ceramic capacitor (MLCC), a multilayer electronic component, may be a chip-type condenser mounted on printed circuit boards of various types of electronic products, such as an image display device, including a liquid crystal display (LCD) or a plasma display panel (PDP), a computer, a smartphone, or a mobile phone, serving to charge or discharge electricity therein or therefrom.

Such a multilayer ceramic capacitor has a small size, implements high capacitance, and is easily mounted on a circuit board, and may thus be used as a component of various electronic devices. There has been increasing demand for a multilayer ceramic capacitor to have a reduced size and higher capacitance as each of various electronic devices such as a computer and a mobile device have a reduced size and higher output.

A multilayer ceramic capacitor may implement dielectric capacitance using a dielectric material. The dielectric material may be mixed with various additives during a manufacturing process thereof, to be manufactured in the form of a liquid slurry, which may be applied onto a film and then dried to be manufactured in the form of a sheet.

However, during a drying process of the slurry, pores may be formed on a surface of the sheet, which may affect the electrical characteristics of the capacitor. In addition, during a process of applying the slurry in the form of a film, a slight thickness deviation may occur, which may result in an inconsistent thickness or uneven characteristics of the manufactured sheet. These problems may affect the quality of a multilayer ceramic capacitor. Although some of the above-described problems are improved by compressing a laminate formed of sheets printed with an internal electrode pattern, but more advanced technical solutions are needed, and other problems may occur during the compressing process of the laminate, which need to be addressed.

### SUMMARY

An aspect of the present disclosure is to provide a ceramic green sheet in which formation of pores is suppressed.

An aspect of the present disclosure is to provide a ceramic green sheet having a small thickness deviation.

An aspect of the present disclosure is to provide a ceramic green sheet having low surface roughness.

An aspect of the present disclosure is to provide a ceramic green sheet having excellent density.

However, various problems to be solved by the present disclosure are not limited to the above-described contents, and can be more easily understood in the process of explaining specific embodiments of the present disclosure.

According to an aspect of the present disclosure, a method for manufacturing a multilayer electronic component may include applying a dielectric slurry onto a film and drying the dielectric slurry to form a ceramic green sheet; performing a Heat Rolling Process (HRP) on the ceramic green sheet to form a compressed ceramic green sheet; forming an internal electrode pattern on the compressed ceramic green sheet; forming a laminate by laminating the compressed ceramic green sheet having the internal electrode pattern formed thereon; forming a body including a dielectric layer and an internal electrode by sintering the laminate; and forming an external electrode on the body, wherein the HRP process applies a temperature of 50°C to 70°C and a pressure of 10 MPa to 20 MPa.

According to an aspect of the present disclosure, a method for manufacturing a ceramic green sheet may include applying a dielectric slurry onto a film and drying the dielectric slurry to form a ceramic green sheet; and performing an HRP process on the ceramic green sheet to form a compressed ceramic green sheet, wherein the HRP process applies a temperature of 50°C to 70°C, and a pressure of 10 MPa to 20 MPa.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 schematically illustrates a process flow diagram of a method for manufacturing a multilayer electronic component according to an embodiment of the present disclosure;

FIG. 2 schematically illustrates some processes in a method for manufacturing a multilayer electronic component;

FIG. 3 schematically illustrates a compressed ceramic green sheet having an internal electrode pattern formed thereon;

FIG. 4A is an image of a cross-section of a ceramic green sheet having an internal electrode pattern formed thereon, manufactured by a conventional method, taken using a scanning electron microscope (SEM), FIG. 4B is an image of a plane of a ceramic green sheet manufactured by a conventional method, taken using a scanning electron microscope (SEM), and FIG. 4C is an image of cross-sections of an internal electrode and a dielectric layer manufactured by a conventional method, taken using a scanning electron microscope (SEM);

FIG. 5A is an image of a cross-section of a compressed ceramic green sheet having an internal electrode pattern formed thereon manufactured according to an embodiment of the present disclosure, taken using a scanning electron microscope (SEM), FIG. 5B is an image of a plane of a compressed ceramic green sheet manufactured according to an embodiment of the present disclosure, taken with a scanning electron microscope (SEM), and FIG. 5C is an image of cross-sections of an internal electrode and a dielectric layer manufactured according to an embodiment of the present disclosure, taken with a scanning electron microscope (SEM);

FIG. 6 schematically illustrates a perspective view of a multilayer electronic component manufactured according to an embodiment of the present disclosure;

FIG. 7 schematically illustrates a cross-sectional view taken along line I-I' of FIG. 6; and

FIG. 8 schematically illustrates a cross-sectional view taken along line II-II' of FIG. 6.

### DETAILED DESCRIPTION

Hereinafter, some embodiments of the present disclosure will be described as follows with reference to the attached drawings. The present disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art. Accordingly, shapes and sizes of elements in the drawings may be exaggerated for clear description, and elements indicated by the same reference numeral are the same elements in the drawings.

In the drawings, irrelevant descriptions will be omitted to clearly describe the present disclosure, and to clearly express a plurality of layers and areas, thicknesses may be magnified. The same elements having the same function within the scope of the same concept will be described with use of the same reference numerals. Throughout the specification, when a component is referred to as “comprise” or “comprising,” it means that it may further include other components as well, rather than excluding other components, unless specifically stated otherwise.

In the drawings, a Z direction may be defined as a thickness direction or a first direction, an X direction may be defined as a length direction or a second direction, and a Y direction may be defined as a width direction or a third direction. A stacking direction may be a thickness direction or a width direction.

In addition, in the present disclosure, thickness may mean a size thereof in the first direction, length may mean a size thereof in the second direction, and width may mean a size thereof in the third direction.

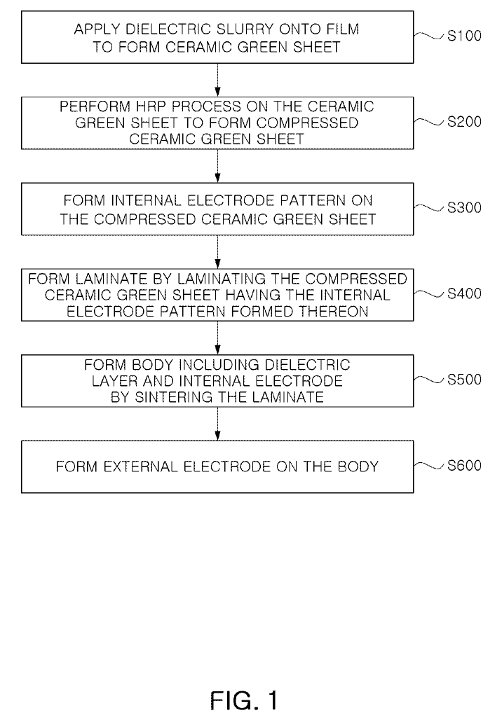

FIG. 1 schematically illustrates a process flow diagram of a method for manufacturing a multilayer electronic component according to an embodiment of the present disclosure.

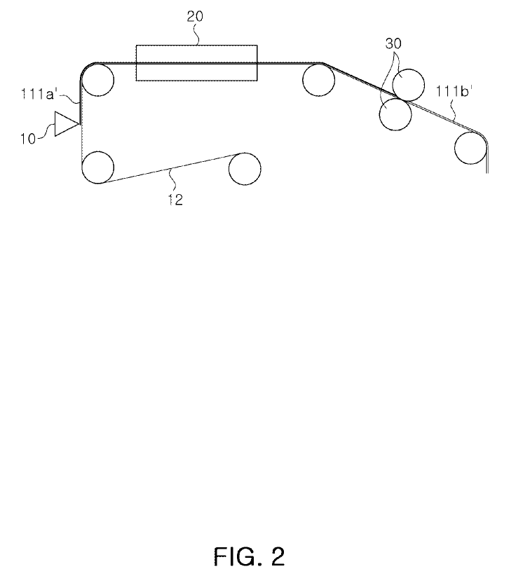

FIG. 2 schematically illustrates some processes in a method for manufacturing a multilayer electronic component.

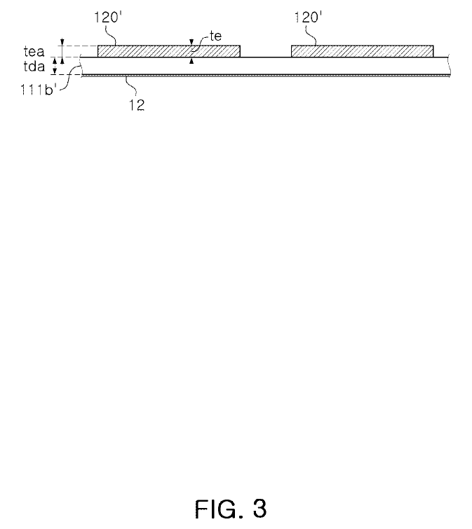

FIG. 3 schematically illustrates a compressed ceramic green sheet having an internal electrode pattern formed thereon.

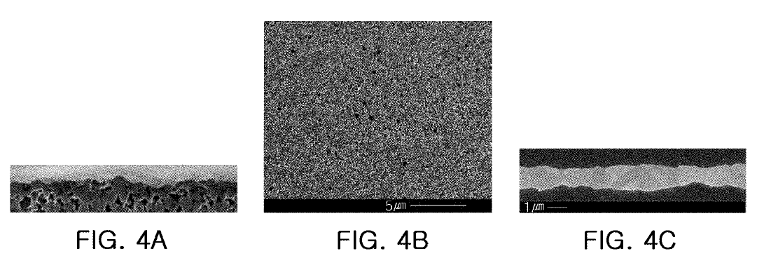

FIG. 4A is an image of a cross-section of a ceramic green sheet having an internal electrode pattern formed thereon manufactured by a conventional method, taken using a scanning electron microscope (SEM), FIG. 4B is an image of a plane of a ceramic green sheet manufactured by a conventional method, taken using a scanning electron microscope (SEM), and FIG. 4C is an image of cross-sections of an internal electrode and a dielectric layer manufactured by a conventional method, taken using a scanning electron microscope (SEM).

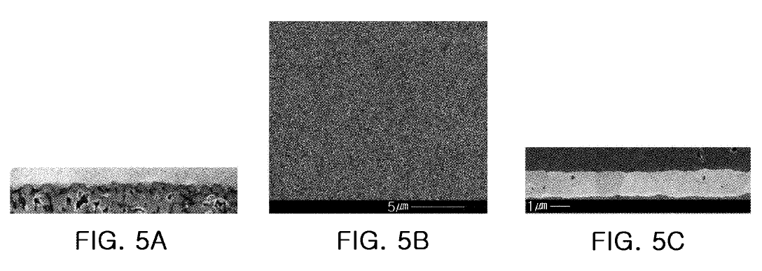

FIG. 5A is an image of a cross-section of a compressed ceramic green sheet having an internal electrode pattern formed thereon manufactured according to an embodiment of the present disclosure, taken using a scanning electron microscope (SEM), FIG. 5B is an image of a plane of a compressed ceramic green sheet manufactured according to an embodiment of the present disclosure, taken with a scanning electron microscope (SEM), and FIG. 5C is an image of cross-sections of an internal electrode and a dielectric layer manufactured according to an embodiment of the present disclosure, taken with a scanning electron microscope (SEM).

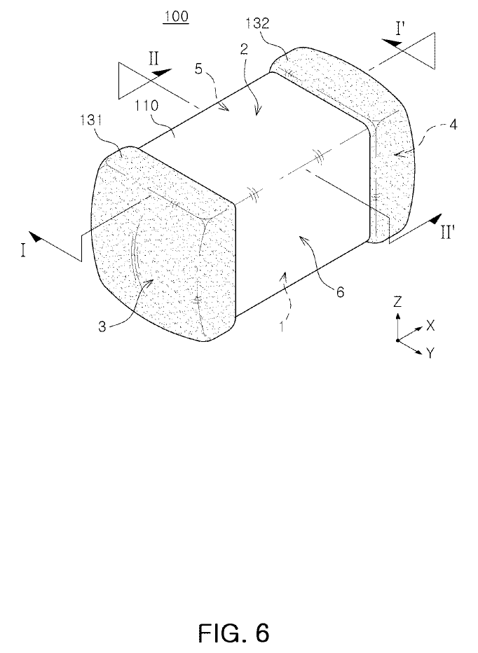

FIG. 6 schematically illustrates a perspective view of a multilayer electronic component manufactured according to an embodiment of the present disclosure.

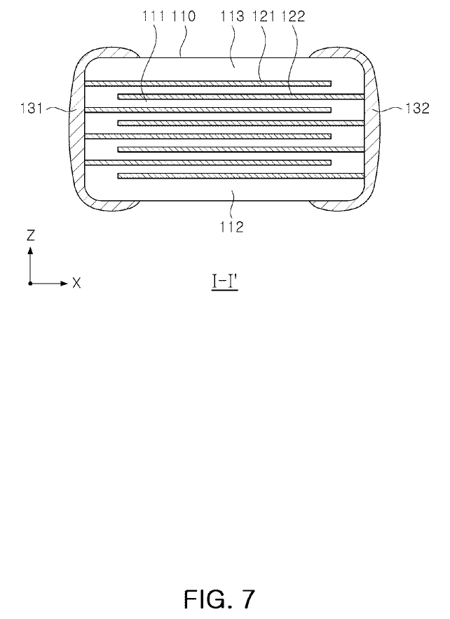

FIG. 7 schematically illustrates a cross-sectional view taken along line I-I' of FIG. 6.

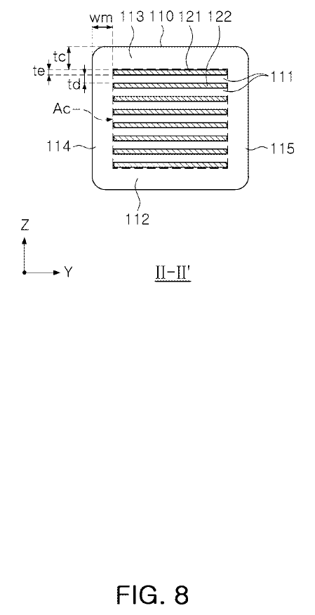

FIG. 8 schematically illustrates a cross-sectional view taken along line II-II' of FIG. 6.

Hereinafter, a multilayer electronic component according to an embodiment of the present disclosure will be described in detail with reference to FIGS. 1 to 8. However, a multilayer ceramic capacitor will be described as an example of a multilayer electronic component, but the example embodiment may also be applied to various electronic products using a dielectric composition, such as an inductor, a piezoelectric element, a varistor, a thermistor, or the like.

According to an embodiment of the present disclosure, a method for manufacturing a multilayer electronic component may include applying a dielectric slurry onto a film 12 and drying the dielectric slurry to form a ceramic green sheet 111a'(S100); performing an HRP process on the ceramic green sheet 111a' to form a compressed ceramic green sheet 111b' (S200); forming an internal electrode pattern 120' on the compressed ceramic green sheet 111b'(S300); forming a laminate by laminating the compressed ceramic green sheet 111b' having the internal electrode pattern 120' formed thereon (S400); forming a body 100 including a dielectric layer 111 and internal electrodes 121 and 122 by sintering the laminate (S500); and forming external electrodes 131 and 132 on the body 100 (S600), wherein the HRP process applies a temperature of 50°C to 70°C and a pressure of 10 MPa to 20 MPa.

According to another embodiment of the present disclosure, a method for manufacturing a ceramic green sheet may include applying a dielectric slurry onto a film and drying the dielectric slurry to form a ceramic green sheet (S100); and performing an HRP process on the ceramic green sheet to form a compressed ceramic green sheet (S200), wherein the HRP process applies a temperature of 50°C to 70°C and a pressure of 10 MPa to 20 MPa.

The method for manufacturing a ceramic green sheet of the present disclosure may correspond to a portion of the method for manufacturing a multilayer electronic component, and the description of the method for manufacturing a ceramic green sheet may be the same as the description of some processes in the method for manufacturing a multilayer electronic component, and thus will be omitted.

The method for manufacturing a multilayer electronic component according to an embodiment of the present disclosure may include applying a dielectric slurry onto a film 12 and drying the dielectric slurry to form a ceramic green sheet (S100).

The film 12 may refer to a release film, and may be a polyester film including polyethylene terephthalate (PET) or polyethylene naphthalate (PEN), but an embodiment thereof is not particularly limited thereto.

The dielectric slurry may include various ceramic additives, organic solvents, or aqueous solvents, binders, dispersants, and the like, added to the dielectric material, and may be in a liquid form.

The dielectric material is not particularly limited, as long as sufficient capacitance may be obtained therewith. In general, a perovskite (ABO₃)-based material may be used for forming the dielectric slurry, and for example, a barium titanate-based material, a lead composite perovskite-based material, a strontium titanate-based material, or the like, may be used. The barium titanate-based material may include a BaTiO₃-based ceramic powder, and examples of the ceramic powder may include BaTiO₃, or (Ba₁₋ₓCaₓ)TiO₃(0<x<1), Ba(Ti_{1-y}Ca_{y})O₃(0<y<1), (Ba₁₋ₓCaₓ)(Ti_{1-y}Zr_{y})O₃(0<x<1, 0<y<1), Ba(Ti_{1-y}Zr_{y})O₃(0<y<1), or the like, in which calcium (Ca), zirconium (Zr), or the like is partially dissolved in BaTiO₃, or the like.

The dielectric slurry may be applied by an inkjet printing method, which is ejected through a discharge port 10 such as a head, but an embodiment thereof is not particularly limited thereto.

The inkjet printing method has the advantage that can apply a large amount of liquid-type dielectric slurry, ejected through a discharge port 10 over a wide area at a constant rate, but has limitations in applying the dielectric slurry with a precise thickness.

The dielectric slurry applied onto the film 12 may be dried in a drying device 20.

A dispersion state of the slurry composition may be controlled by drying the dielectric slurry and adjusting viscosity of the slurry. However, as moisture evaporates during the drying process, pores may be formed on the surface, and a thickness deviation may occur.

Next, performing an HRP on a ceramic green sheet 111a' to form a compressed ceramic green sheet 111b'(S200) may be performed.

The HRP may be performed by applying a temperature of 50°C to 70°C and a pressure of 10 MPa to 20 MPa.

More specifically, the HRP may mean a process of heating and pressing the ceramic green sheet 111a' in a thickness direction by passing the same between heating and pressing rollers 30. The ceramic green sheet 111a' may be made into a compressed ceramic green sheet 111b'.

In this case, a heating temperature of the HRP may be 50°C to 70°C, and the pressing pressure may be 10 MPa to 20 MPa.

By satisfying the heating temperature of the HRP process of 50°C to 70°C and the pressing pressure of 10 MPa to 20 MPa, the pores on the surface formed during the drying process of the ceramic green sheet 111a' may be effectively removed, and the thickness deviation may be minimized to provide a compressed ceramic green sheet 111b' with improved pores and smoothness of the sheet.

Here, the compressed ceramic green sheet 111b' is defined only to be distinguished from the ceramic green sheet 111a' before the HRP, and it will be obvious to a person skilled in the art that it may be an example of a ceramic green sheet.

When the heating temperature of the HRP is less than 50°C or the pressing pressure is less than 10 MPa, there is a concern that the ceramic green sheet 111a' may not be sufficiently heated or pressed, resulting in pores not being removed or thickness deviation not being reduced. When the heating temperature of the HRP exceeds 70°C or the pressing pressure is less than 20 MPa, there is a risk of excessive deformation of the ceramic green sheet 111a'.

The HRP may be performed at least once, and as the HRP is repeatedly performed a plurality of times, the removal of pores on the surface and minimization of thickness deviation of the compressed ceramic green sheet 111b' may be further improved.

The following description will be made by comparing FIGS. 4A to 4C in which the HRP process is not applied, with FIGS. 5A to 5C in which the HRP process is applied.

More specifically, FIG. 4A is an image of a cross-section of a ceramic green sheet having an internal electrode pattern formed thereon, manufactured by a conventional method, without applying the HRP process, taken using a scanning electron microscope (SEM), FIG. 4B is an image of a plane of a ceramic green sheet manufactured by a conventional method, taken using the SEM, and FIG. 4C is an image of cross-sections of an internal electrode and a dielectric layer manufactured by a conventional method, taken using the SEM.

FIG. 5A is an image of a cross-section of a compressed ceramic green sheet having an internal electrode pattern formed thereon, according to an embodiment of the present disclosure, with applying the HRP , taken using the SEM, FIG. 5B is an image of a plane of a compressed ceramic green sheet manufactured according to an embodiment of the present disclosure, taken with the SEM, and FIG. 5C is an image of cross-sections of an internal electrode and a dielectric layer manufactured according to an embodiment of the present disclosure, taken with the SEM.

When comparing FIGS. 4A and 5A, an interface between a ceramic green sheet and an internal electrode pattern without applying the HRP appears to be relatively rough, when an average thickness of the ceramic green sheet is 5.2 μm, a thickness deviation of the ceramic green sheet is 0.029 μm, which exhibits a relatively large thickness deviation, while an interface between a compressed ceramic green sheet and an internal electrode pattern with applying the HRP process appears to be relatively flat, and when an average thickness of the compressed ceramic green sheet is 5.2 μm, a thickness deviation of the compressed ceramic green sheet is 0.005 μm, which exhibits a relatively small thickness deviation.

When comparing FIGS. 4B and 4B, it can be seen that the ceramic green sheet without applying the HRP has relatively many pores observed on the surface, has low density, and has 10-point surface roughness (Rz) of 0.125 μm, which is somewhat high, while the compressed ceramic green sheet with applying the HRP process has relatively few pores observed on the surface, has high density, and has 10-point surface roughness (Rz) of 0.07 μm, which is somewhat low.

Finally, when comparing FIGS. 4C and 5C, it can be seen that the flatness of the dielectric layer and the internal electrode is inferior when observing cross-sections of the dielectric layer and the internal electrode when the HRP is not applied, while the flatness of the dielectric layer and the internal electrode is improved when observing the cross-sections of the dielectric layer and the internal electrode when the HRP process is applied.

Therefrom, when the HRP is applied, it can be seen that the thickness deviation of the ceramic green sheet and/or the internal electrode pattern is improved, the pores on the surface of the ceramic green sheet are more effectively removed, and the density is improved.

Ten-point average roughness (Rz) of the compressed ceramic green sheet 111b' to which the HRP process is applied may be less than 0.125 μm, preferably 0.1 μm or less, and more preferably 0.07 μm or less. That is, Rz < 0.125 μm may be satisfied.

Ten-point average roughness (Rz) is one of indices used in surface roughness measurement, and may mean an average difference between the five highest points and the five lowest points in a surface region to be measured. This is a method of measuring relative height changes when evaluating the surface roughness.

A lower Rz value may indicate no surface pores or a flat surface, and thus the Rz value closer to 0 μm may be preferable. A lower limit value of Rz is not particularly limited, but Rz may be 0 μm or more, 0.001 μm or more, or 0.01 μm or more, but is not specifically limited thereto.

A thickness standard deviation (tdStdev) of the compressed ceramic green sheet 111b' to which the HRP process is applied may be less than 0.029 μm, preferably 0.02 μm or less, 0.01 μm or less, and more preferably 0.005 μm or less. That is, tdStdev < 0.125 μm can be satisfied.

A standard deviation may mean a statistical indicator indicating how much the values in collected data are spread out from an average value. Thickness standard deviation may be used to evaluate how consistently thickness values measured at multiple points are distributed relative to the average thickness.

A lower tdStdev value may mean that there is no deviation in the thickness (td) of the compressed ceramic green sheet relative to the average thickness (tda) of the compressed ceramic green sheet, and thus a value closer to 0 μm may be preferable. A lower limit value of the tdStdev is not specifically limited, but tdStdev may be 0 μm or more or 0.001 μm or more.

The thickness of the compressed ceramic green sheet may be somewhat deformed during the sintering process, but may be similar to a thickness of a dielectric layer after sintering, and in the present disclosure, the thickness of the compressed ceramic green sheet and the thickness of the dielectric layer may be described as td without distinction therebetween, but a person skilled in the art may easily understand the difference between the thickness of the compressed ceramic green sheet and the thickness of the dielectric layer.

An average thickness (tda) of the compressed ceramic green sheet is not particularly limited, but may be 1 μm or more. That is, 1 μm ≤ tda may be satisfied.

When the tda of the compressed ceramic green sheet is less than 1 μm, there is a risk that excessive compression or deformation may occur due to the HRP process.

An upper limit value of the tda thereof is not specifically limited, but the tda may be 20 μm or less, and preferably 10 μm or less.

In the present disclosure, it may be preferable to perform the HRP before forming an internal electrode pattern 120'.

When applying a heating and pressing process to a ceramic green sheet 111a' having the internal electrode pattern 120'formed thereon, the internal electrode pattern 120' may be introduced into the ceramic green sheet 111a' by the heating and pressing process, thereby, a thickness deviation of the ceramic green sheet 111a' or the internal electrode 120' may be worsened, and due thereto, a step or stacking mismatch may occur due to repeated stacking of the dielectric layer 111 and the internal electrodes 121 and 122. In addition, since the heating and pressing process is not applied to a region of the ceramic green sheet 111a' having the internal electrode pattern 120' formed thereon, pores on the surface of the ceramic green sheet 120' may remain without being removed, which may deteriorate the electrical characteristics of the multilayer electronic component 100 in the future.

Next, forming an internal electrode pattern 120' on the compressed green sheet 111b' may be performed (S300).

The internal electrode pattern 120' may be formed using a method such as screen printing or gravure printing of a paste for internal electrodes, but an embodiment thereof is not particularly limited thereto.

A material for forming the internal electrode pattern 120' is not particularly limited, and may include a material having excellent electrical conductivity. For example, the internal electrode pattern 120' may include at least one selected from the group consisting of nickel (Ni), copper (Cu), palladium (Pd), silver (Ag), gold (Au), platinum (Pt), tin (Sn), tungsten (W), titanium (Ti), and alloys thereof.

The internal electrode pattern 120' may be a first internal electrode pattern or a second internal electrode pattern depending on a surface thereof exposed in a laminate to be described later, and through a sintering process, the first internal electrode pattern may be a first internal electrode, and the second internal electrode pattern may be a second internal electrode.

A thickness standard deviation (teStdev) of the internal electrode pattern 120' may be 0.029 μm or less, preferably 0.02 μm or less, 0.01 μm or less, and more preferably 0.005 μm or less. That is, teStdev < 0.125 μm may be satisfied.

A lower teStdev value may mean that there is no deviation in a thickness (te) of the internal electrode pattern relative to an average thickness (tea) of the internal electrode pattern, so a value closer to 0 μm may be preferable. A lower limit value of the thickness standard deviation (teStdev) is not specifically limited, but the teStdev may be 0 μm or more or 0.001 μm or more.

The thickness of the internal electrode pattern may be somewhat deformed during the sintering process, but may be similar to the thickness of the internal electrode after sintering, and in the present disclosure, the thickness of the internal electrode pattern and the thickness of the internal electrode may be described as te without distinction therebetween. A person skilled in the art will be able to easily understand the difference between the thickness of the internal electrode pattern and the thickness of the internal electrode.

Next, an operation of forming a laminate by laminating a compressed ceramic green sheet 111b' having an internal electrode pattern 120' formed thereon may be performed (S400).

The laminate forms a plurality of internal electrode patterns 120' at predetermined intervals on the compressed ceramic green sheet 111b'. The internal electrode pattern 120' may be classified as a first internal electrode pattern or a second internal electrode pattern depending on the exposed surface, a compressed ceramic green sheet having a first internal electrode pattern formed thereon may be referred to as a first compressed ceramic green sheet, and a compressed ceramic green sheet having a second internal electrode pattern formed thereon may be referred to as a second compressed ceramic green sheet.

The first and second compressed ceramic green sheets may be alternately laminated so that the first internal electrode pattern and the second internal electrode pattern are cross-laminated.

A portion in which the first and second internal electrode patterns are cross-laminated with the compressed ceramic green sheet interposed therebetween to form capacitance may be defined as a green capacitance forming portion.

In this case, a cover portion green sheet may be disposed on both end surfaces of the green capacitance forming portion in a first direction, and more specifically, the cover portion green sheet may include a first cover portion green sheet disposed below the green capacitance forming portion in the first direction, and a second cover portion green sheet disposed above the green capacitance forming portion in the first direction.

Next, forming a body 110 including a dielectric layer 111 and internal electrodes 121 and 122 may be performed by sintering the laminate (S500).

Through the sintering process, the compressed ceramic green sheet may be a dielectric layer 111, the first internal electrode pattern may be a first internal electrode 121, and the second internal electrode pattern may be a second internal electrode 122. In addition, the first cover portion green sheet may be a first cover portion 112, and the second cover portion green sheet may be a second cover portion 113.

Next, forming external electrodes 131 and 132 on the body 110 may be performed (S600).

In the present disclosure, a structure in which the multilayer electronic component 100 has two external electrodes 131 and 132 is illustrated, but the number, shapes, or the like of the external electrodes 131 and 132 may be changed, depending on a shape of the internal electrodes 121 and 122, or other purposes.

First, a paste for a first external electrode may be applied to one surface of the sintered body 110, and a paste for a second external electrode may be applied to the other surface facing the one surface.

A paste for external electrodes may be formed by transferring a sheet including a conductive metal onto the body 110, or may be formed by dipping the body 110 into a paste for an external electrode, but an embodiment thereof is not particularly limited thereto.

After applying the paste for the external electrode to the body 110, a sintering process may be performed to form external electrodes 131 and 132.

The external electrodes 131 and 132 may be connected to the internal electrodes 121 and 122, and a conductive metal used in the paste for the external electrodes to be the external electrodes is not particularly limited, as long as it is a material that can be electrically connected to the internal electrodes to form electrostatic capacitance. For example, the external electrodes 131 and 132 may include at least one selected from the group consisting of nickel (Ni), copper (Cu), palladium (Pd), silver (Ag), gold (Au), platinum (Pt), tin (Sn), tungsten (W), titanium (Ti) and alloys thereof.

Hereinafter, a multilayer electronic component 100 will be described in more detail.

The body 110 may have the dielectric layer 111 and the internal electrodes 121 and 122 alternately stacked.

More specifically, the body 110 may include a capacitance forming portion (Ac) disposed in the body 110 and including a first internal electrode 121 and a second internal electrode 122, alternately disposed to face each other with the dielectric layer 111 interposed therebetween, to form capacitance.

The body 110 is not limited to a particular shape, and may have a hexahedral shape or a shape similar to the hexahedral shape, as illustrated in the drawings. The body 110 may not have the shape of a hexahedron having perfectly straight lines because ceramic powder particles included in the body 110 are contracted in a process in which the body is sintered. However, the body 110 may have a substantially hexahedral shape.

The body 110 may have first and second surfaces 1 and 2 opposing each other in a thickness direction, third and fourth surfaces 3 and 4 connected to the first and second surfaces 1 and 2 and opposing each other in a length direction, and fifth and sixth surfaces 5 and 6 connected to the first to fourth surfaces 1,2,3, and 4 and opposing each other in a width direction.

A plurality of dielectric layers 111 forming the body 110 may be in a sintered state, and adjacent dielectric layers 111 may be integrated with each other, such that boundaries therebetween may not be readily apparent without a scanning electron microscope (SEM).

A raw material for forming the dielectric layer 111 has been described above, and thus the description will be omitted.

Meanwhile, in order to distinguish the dielectric layer 111 from a dielectric layer included in cover portions 112 and 113 and side margin portions 114 and 115, described later, a dielectric layer included in the capacitance forming portion (Ac) may be defined as a first dielectric layer, a dielectric layer included in the cover portions 112 and 113 may be defined as a second dielectric layer, and a dielectric layer included in the side margin portions 114 and 115 may be defined as a third dielectric layer.

Since the first to third dielectric layers may be formed using a dielectric material such as barium titanate (BaTiO₃), the first to third dielectric layers may include a dielectric microstructure after sintering. The dielectric microstructure may include a plurality of grains, grain boundaries disposed between the adjacent grains, and triple points disposed at points at which three or more grain boundaries meet, and may respectively include a plurality of grains, grain boundaries, and triple points.

The internal electrodes 121 and 122 may be alternately stacked with the dielectric layer 111.

The internal electrodes 121 and 122 may include a first internal electrode and a second internal electrode 122, and the first and second internal electrodes 121 and 122 may be alternately disposed to oppose each other with the dielectric layers 111, constituting the body 110, interposed therebetween, and may be exposed to the third and fourth surfaces 3 and 4 of the body 110, respectively.

More specifically, the first internal electrode 121 may be spaced apart from the fourth surface 4 and exposed through the third surface 3, and the second internal electrode 122 may be spaced apart from the third surface 3 and exposed through the fourth surface 4. A first external electrode 131 may be disposed on the third surface 3 of the body 110 and connected to the first internal electrode 121, and a second external electrode 132 may be disposed on the fourth surface 4 of the body 110 and connected to the second internal electrode 122.

That is, the first internal electrode 121 may not be connected to the second external electrode 132, but may be connected to the first external electrode 131, and the second internal electrode 122 may not be connected to the first external electrode 131, but may be connected to the second external electrode 132. In this case, the first and second internal electrodes 121 and 122 may be electrically separated from each other by the dielectric layer 111 disposed in the middle.

Meanwhile, the body 110 may include cover portions 112 and 113 disposed on both end surfaces of the capacitance forming portion (Ac) in a thickness direction.

Specifically, the cover portions 112 and 113 may include a first cover portion 112 disposed on one surface of the Ac in a thickness direction and a second cover portion 113 disposed on the other surface of the Ac in the thickness direction. More specifically, for example, the cover portions 112 and 113 may include a first cover portion 112 disposed below the Ac in the thickness direction and a second cover portion 113 disposed above the Ac in the thickness direction.

The first cover portion 112 and the second cover portion 113 may be formed by disposing or stacking a single second dielectric layer or two or more second dielectric layers on upper and lower surfaces of the Ac in the thickness direction, respectively, and may basically play a role in preventing damage to the internal electrodes 121 and 122 due to physical or chemical stress.

The first cover portion 112 and the second cover portion 113 may not include the internal electrodes 121 and 122, and may include the same dielectric material as the first dielectric layer 111 of the capacitance forming portion (Ac). That is, the first cover portion 112 and the second cover portion 113 may include a ceramic material, and may include, for example, a barium titanate (BaTiO₃)-based ceramic material.

Meanwhile, the multilayer electronic component 100 may include side margin portions 114 and 115, end regions of the internal electrodes 121 and 122 in a width direction.

More specifically, the side margin portions 114 and 115 may include a first side margin portion 114 disposed between the internal electrodes 121 and 122 and the fifth surface 5 and a second side margin portion 115 disposed between the internal electrodes 121 and 122 and the sixth surface 6.

As illustrated, the side margin portions 114 and 115 may refer to regions between both ends of the first and second internal electrodes 121 and 122 in the width direction and a boundary surface of the body 110, based on a cross-section of the body 110 cut in the width and thickness directions.

The side margin portions 114 and 115 may refer to a ceramic green sheet region except for the internal electrodes 121 and 122, when a paste for internal electrodes is applied to a ceramic green sheet applied to the capacitance forming portion (Ac), except for a portion in which the side margin portions 114 and 115 are to be formed.

However, the present disclosure is not limited thereto, and the side margin portions 114 and 115 may be formed by applying a conductive paste on a ceramic green sheet to form the internal electrodes 121 and 122, except for a portion in which the side margin portions 114 and 115 are to be formed, and to suppress a step difference due to the internal electrodes 121 and 122, may also be formed by cutting the internal electrodes 121 and 122 to be exposed to the fifth and sixth surfaces 5 and 6 of the body 110, and then stacking or disposing a single third dielectric layer or two or more third dielectric layers in the width direction on both end-surfaces of the capacitance forming portion (Ac) in the width direction.

The side margin portions 114 and 115 may basically play a role in preventing damage to the internal electrodes 121 and 122 due to physical or chemical stress.

The first side margin portion 114 the second side margin portion 115 may not include the internal electrodes 121 and 122, and may include the same dielectric material as the first dielectric layer 111, and may correspond to, for example, a portion of the first dielectric layer 111. That is, the first side margin portion 114 and the second side margin portion 115 may include a ceramic material, and may include, for example, a barium titanate (BaTiO₃)-based ceramic material.

Meanwhile, a width “wm” of the side margin portions 114 and 115 does not need to be particularly limited, and hereinafter, the description of the width “wm” of the side margin portions 114 and 115 may mean the width “wm” of each of the first side margin portion 114 and the second side margin portion 115.

To more easily achieve miniaturization and high capacitance of the multilayer electronic component 100, the width “wm” of the side margin portion may be 50 μm or less, preferably 30 μm or less, and in the case of ultra-small products, more preferably 20 μm or less.

Here, the width “wm” of the side margin portions 114 and 115 may mean an average width “wm” of the side margin portions 114 and 115.

In addition, the average width “wm” of the side margin portions 114 and 115 may mean an average width “wm” of each of the first and second side margin portions 114 and 115, or an average width “wm” of the first and second side margin portions 114 and 115.

The average width “wm” of the side margin portions 114 and 115 may be measured by scanning an image of a cross-section of the body 110 in the width and thickness directions with a scanning electron microscope (SEM) at a magnification of 10,000. More specifically, the average width “wm” of the side margin portions 114 and 115 may refer to an average value calculated by measuring widths at five equally spaced points in the thickness direction in the scanned image of one side margin portion (114, 115).

External electrodes 131 and 132 may be disposed on the body 110 and connected to the internal electrodes 121 and 122.

More specifically, the external electrodes 131 and 132 may include first and second external electrodes 131 and 132 respectively disposed on the third and fourth surfaces 3 and 4 of the body 110, and respectively connected to the first and second internal electrodes 121 and 122. That is, a first external electrode 131 may be disposed on the third surface 3 of the body and connected to the first internal electrode 121, and a second external electrode 132 may be disposed on the fourth surface 4 of the body and connected to the second internal electrode 122.

In addition, the external electrodes 131 and 132 may be disposed to extend onto portions of the first and second surfaces 1 and 2 of the body 110, or may be disposed to extend onto portions of the fifth and sixth surfaces 5 and 6 of the body 110. That is, the first external electrode 131 may be disposed on the third surface 3 of the body 110 and portions of the first, second, fifth, and sixth surfaces 1, 2, 5, and 6 of the body 110, and the second external electrode 132 may be disposed on the fourth surface 4 of the body 110 and portions of the first, second, fifth, and sixth surfaces 1, 2, 5, and 6 of the body 110.

The external electrodes 131 and 132 may include a first electrode layer disposed on the body 110 and a second electrode layer disposed on the first electrode layer.

Here, it may be preferable that the first and second electrode layers correspond to layers, which are distinguished from each other. However, the present disclosure is not particularly limited, and the first and second electrode layers may be distinguished according to a manufacturing process order, and the first and second electrode layers may be observed as a single layer, without being distinguished from each other.

In the present disclosure, “being distinguished” may mean that two layers are distinguished due to physical differences, chemical differences, and/or simple optical differences, and is not particularly limited thereto, but the distinction between layers may be made by the presence or absence of an “interface.” An interface may mean a surface in which two layers in contact with each other may be distinguished from each other, and may mean a state in which the two layers may be distinguished by differences in components, such as through EDS analysis using equipment such as a scanning electron microscope (SEM).

A size of the multilayer electronic component 100 does not need to be particularly limited.

However, to achieve both miniaturization and high capacitance, thicknesses of the dielectric layer and internal electrodes should be thinned to increase the number of stacks. Therefore, an effect according to the present disclosure may become more noticeable in a multilayer electronic component 100 having a size of 2012 (length × width: 2.0 mm × 1.2 mm, and length and width satisfy an error of within ±10%) or less. In addition, the multilayer electronic component 100 may have a width greater than a length.

As set forth above, according to one of the many effects of the present disclosure, formation of pores in a ceramic green sheet may be suppressed.

According to one of many effects of the present disclosure, a thickness deviation of a ceramic green sheet may be reduced.

According to one of many effects of the present disclosure, surface roughness of a ceramic green sheet may be reduced.

According to one of many effects of the present disclosure, density of a ceramic green sheet may be improved.

However, various advantages and effects of the present disclosure are not limited to the above-described contents, and can be more easily understood in a process of explaining specific embodiments of the present disclosure.

Although the embodiments of the present disclosure have been described in detail above, the present disclosure is not limited by the above-described embodiments and the attached drawings, but is intended to be limited by the appended claims. Accordingly, various forms of substitution, modification, and change may be made by those skilled in the art within the scope that does not depart from the technical idea of the present disclosure described in the claims, and this will also fall within the scope of the present disclosure.

In addition, the expression ‘an embodiment’ used in this specification does not mean the same embodiment, and may be provided to emphasize and describe different unique characteristics. However, an embodiment presented above may not be excluded from being implemented in combination with features of another embodiment. For example, although the description in a specific embodiment is not described in another example, it can be understood as an explanation related to another example, unless otherwise described or contradicted by the other embodiment.

The terms used in this disclosure are used only to illustrate various examples and are not intended to limit the present inventive concept. Singular expressions include plural expressions unless the context clearly dictates otherwise.

While example embodiments have been illustrated and described above, it will be apparent to those skilled in the art that modifications and variations could be made without departing from the scope of the present disclosure as defined by the appended claims.

What is claimed is:

1. A method for manufacturing a multilayer electronic component, comprising:
applying a dielectric slurry onto a film,
drying the dielectric slurry to form a ceramic green sheet;
performing a Heat Rolling Process (HRP) on the ceramic green sheet to form a compressed ceramic green sheet;
forming an internal electrode pattern on the compressed ceramic green sheet;
forming a laminate by laminating the compressed ceramic green sheet having the internal electrode pattern formed thereon;
forming a body including a dielectric layer and an internal electrode by sintering the laminate; and
forming an external electrode on the body,
wherein the HRP applies a temperature of 50°C to 70°C and a pressure of 10 MPa to 20 MPa.

2. The method for manufacturing a multilayer electronic component of claim 1, wherein in the applying the dielectric slurry, the dielectric slurry is applied in a manner of being ejected through a discharge port.

3. The method for manufacturing a multilayer electronic component of claim 1, wherein in the forming the compressed ceramic green sheet, the HRP is performed at least once.

4. The method for manufacturing a multilayer electronic component of claim 1, wherein ten-point average roughness (Rz) of the compressed ceramic green sheet satisfies Rz < 0.125 μm.

5. The method for manufacturing a multilayer electronic component of claim 1, wherein a thickness standard deviation (tdStdev) of the compressed ceramic green sheet satisfies tdStdev < 0.029 μm.

6. The method for manufacturing a multilayer electronic component of claim 1, wherein an average thickness (tda) of the compressed ceramic green sheet satisfies 1 μm ≤ tda.

7. The method for manufacturing a multilayer electronic component of claim 1, wherein a thickness standard deviation (teStdev) of the internal electrode pattern satisfies teStdev < 0.029 μm.

8. A method for manufacturing a ceramic green sheet, comprising:
applying a dielectric slurry onto a film,
drying the dielectric slurry to form a ceramic green sheet; and
performing a Heat Rolling Process (HRP) on the ceramic green sheet to form a compressed ceramic green sheet,
wherein the HRP applies a temperature of 50°C to 70°C, and a pressure of 10 MPa to 20 MPa.

9. The method for manufacturing a ceramic green sheet of claim 8, wherein in the forming the ceramic green sheet, the dielectric slurry is applied in a manner of being ejected through a discharge port.

10. The method for manufacturing a ceramic green sheet of claim 8, wherein in the forming the compressed ceramic green sheet, the HRP is performed at least once.

11. The method for manufacturing a ceramic green sheet of claim 8, wherein ten-point average roughness (Rz) of the compressed ceramic green sheet satisfies Rz < 0.125 μm.

12. The method for manufacturing a ceramic green sheet of claim 8, wherein a thickness standard deviation (tdStdev) of the compressed ceramic green sheet satisfies tdStdev < 0.029 μm.

13. The method for manufacturing a ceramic green sheet of claim 8, wherein an average thickness (tda) of the compressed ceramic green sheet satisfies 1 μm ≤ tda.

14. The method for manufacturing a ceramic green sheet of claim 8, further comprising forming an internal electrode pattern on the compressed ceramic green sheet.

15. The method for manufacturing a ceramic green sheet of claim 14, wherein a thickness standard deviation (teStdev) of the internal electrode pattern satisfies teStdev < 0.029 μm.

16. The method for manufacturing a multilayer electronic component of claim 1, wherein the dielectric slurry includes a BaTiO₃-based ceramic powder selected from the group consisting of BaTiO₃ or (Ba₁₋ₓCaₓ)TiO₃(0<x<1), Ba(Ti_{1-y}Ca_{y})O₃(0<y<1), (Ba₁₋ₓCaₓ)(Ti_{1-y}Zr_{y})O₃(0<x<1, 0<y<1), and Ba(Ti_{1-y}Zr_{y})O₃(0<y<1).

17. The method for manufacturing a multilayer electronic component of claim 1, wherein the film comprises a polyester film including polyethylene terephthalate (PET) or polyethylene naphthalate (PEN).
